(19) United States
(12) Patent Application Publication
(10) Pub. No.: US 2018/0047037 A1
(43) Pub. Date: Feb. 15, 2018

(54) Device, System, and Method for Temporal Matching Survey Respondents

(71) Applicant: Viacom International Inc., New York, NY (US)

(72) Inventors: Fabio LUZZI, New York, NY (US); Dimitry Slavin, New York, NY (US); Caroline Epstein, New York, NY (US)

(21) Appl. No.: 15/235,446

(22) Filed: Aug. 12, 2016

(51) Int. Cl. G06Q 30/02

(52) U.S. Cl. CPC G06Q 30/0203; G06Q 30/0201; G06Q 30/0204

(57) ABSTRACT

A device, system, and method temporally matches survey respondents. The method performed in an analysis server includes determining a first respondent included in a first sample pool for a first timeframe who is absent from a second sample pool including a plurality of second respondents for a second, later timeframe. The method includes determining a similarity value between the first respondent and each of the second respondents. The method includes generating a link between the first respondent and one of the second respondents where the similarity value is indicative of a match.

### BACKGROUND INFORMATION

Media content may be broadcast in a variety of ways. A conventional way of broadcasting media content is through a television. The television may utilize a broadcast signal received from a distributor such as a programming provider or multichannel video-programming distributor (MVPD). The distributor may receive media content from one or more producers.

There are various systems and devices utilized in gathering information regarding the playback of the media content by televisions. Specifically, the systems may track viewing behavior of individuals and/or households. This information may then be manipulated to determine general viewing behavior for different demographics, different geographic locations, different shows, different timeslots, etc. Accordingly, the distributors and/or producers may be provided with the viewing behavior information for various reasons such as targeted advertising.

However, a problem with this tracking data is that the respondent sample changes over time and it is not possible to correlate current respondents with future respondents. For example, at the current time, Respondents A, B, and C may be part of the sample. After a year, Respondents A, B, and C may be replaced with respondents D, E, and F. After another period of time, Respondents D, E, and F may be replaced with Respondents G, H, and I, and so on. At this later time, the distributors and/or producers may want to know the current viewing habits of Respondents A, B, and C, but they are no longer part of the sample and therefore there is no data available for these respondents.

### SUMMARY

The exemplary embodiments are directed to a method, comprising: in an analysis server: determining a first respondent included in a first sample pool for a first timeframe who is absent from a second sample pool including a plurality of second respondents for a second, later timeframe; determining a similarity value between the first respondent and each of the second respondents; and generating a link between the first respondent and one of the second respondents where the similarity value is indicative of a match.

The exemplary embodiments are directed to an analysis server, comprising: a transceiver configured to receive data of viewing behavior associated with a first respondent included in a first sample pool for a first timeframe and a plurality of second respondents for a second, later timeframe; and a processor configured to determine the first respondent is absent from the second sample pool, the processor configured to determine a similarity value between the first respondent and each of the second respondents, and the processor configured to generate a link between the first respondent and one of the second respondents where the similarity value is indicative of a match.

The exemplary embodiments are directed to a method, comprising: in an analysis server: determining a first respondent included in a first sample pool for a first timeframe who is absent from a second sample pool including a plurality of second respondents for a second, later timeframe; determining a demographic value based on first demographic information associated with the first respondent and second demographic information associated with each of the second respondents; filtering the second respondents based on the demographic value; determining one of the second respondents from the filtered second respondents based on a viewing value based on a first duration of each of at least one show watched by the first respondent and a second duration of each of at least one show watched by each of the second respondents; and generating a link between the first respondent and the one of the second respondents.

### BRIEF DESCRIPTION OF THE DRAWINGS

FIG. 1 shows a system according to the exemplary embodiments.

FIG. 2 shows an analysis server of FIG. 1 according to the exemplary embodiments.

FIG. 3 shows a timeline according to the exemplary embodiments.

FIG. 4 shows a sample analysis according to the exemplary embodiments.

FIG. 5 shows a method of temporally matching a removed respondent with a current respondent according to the exemplary embodiments.

### DETAILED DESCRIPTION

The exemplary embodiments may be further understood with reference to the following description and the related appended drawings, wherein like elements are provided with the same reference numerals. The exemplary embodiments are related to a device, system, and method for temporally matching survey respondents. Specifically, the exemplary embodiments provide a mechanism in which viewing behavior of respondents are utilized to prevent information loss due to a respondent being removed from a sample pool. As will be described in further detail below, a removed respondent may be matched with a current respondent such that viewing behavior of the current respondent may be correlated with the removed respondent. In this manner, the viewing behavior of the removed respondent may still be used to provide information to the distributors and/or producers.

The viewing behavior of an audience provides invaluable information to various outlets. For example, the viewing behavior may indicate (1) what shows are being watched by the audience, (2) for how long these shows are being watched, and (3) the demographic distributions of the audience for these shows. To represent the audience (e.g., the population of the United States), a system may sample a subset of the audience. For example, approximately 20,000 households consisting of about 110,000 respondents may be used to represent the audience. The system may utilize various features such as a dynamic weight for each respondent. The dynamic weight may be regularly adjusted to ensure that the data corresponding to the respondent's viewing behavior remains demographically representative through the time that the respondent is providing the data. The respondents who provide the data of their viewing behavior are provided specialized hardware that transmit the data to the system. Although every member of the audience being provided the specialized hardware and transmitting the data permanently may provide the most thorough data of the viewing behavior, those skilled in the art will understand that, with the current overall audience size, it is impractical for such an implementation. The exemplary embodiments assume that the respondents are a subset of the overall audience chosen for a given time period.

The individuals included in the respondents for a given time period fluctuate. That is, a subset of a first set of respondents may be maintained for an ensuing second set of respondents. However, a remainder subset of the first set of respondents are replaced for a replacement subset to be included in the second set of respondents. For example, the first set of respondents may include Respondents A, B, C, D, E. A second set of respondents may include Respondents C, D, E, F, G. Thus, Respondents C, D, and E are common to the first and second sets, while Respondents F and G replaced Respondents A and B from the first set to the second set. Accordingly, each set of respondents potentially have replacements in each given time period. Those skilled in the art will understand that the replacements in the set of respondents are necessary. For example, replacements may provide sufficient diversity as the demographics and viewing behavior relate to a more generalized population of the audience. In another example, a bias associated with a sample pool may be minimized through the routine replacement of existing respondents with new respondents. However, this replacement operation makes it nearly impossible to track a respondent's viewing behavior over time periods longer than a predetermined average time frame. For example, a respondent has an average turnover time of approximately six months. Thus, the viewing behavior of a specific respondent would only be tracked for around six months. This creates issues for audience measurement initiatives such as the promotional marketing.

With the sample pool from which the data corresponding to the viewing behavior being derived having a massive turnover (e.g., within a given year), analyses of the viewing behavior for a respondent may not be sufficient to generate a meaningful conclusion about presently-airing shows that the target audience is watching. Although advanced analyses may be performed to create summaries of target audiences' viewing behavior (e.g., a marketing team may make educated decisions about where and when to run promotions for upcoming television shows), the promotions may be for the show's season premiere and the determined target audience may be the viewers of the show's previous season. However, the previous season airs nearly a year before the planned promotion for the season premiere. The viewing behavior of the aired show relates to respondents who may no longer provide data corresponding to their viewing behavior as the respondents are likely no longer part of the sample pool. Therefore, the targeting analytics that may be provided become severely limited in scope. Furthermore, there is a high probability that the shows do not continue from a first sample pool to a second sample pool (e.g., shows being canceled, new shows being aired, etc.).

In an attempt to utilize data for viewing behavior associated with removed respondents, analyses may still be performed with outdated data, aggregation of the data to be more general and include only less time-dependent attributes (e.g., genre, keyword, etc.), or use of a proxy for future viewing behavior. However, these approaches are still based upon the fundamental parameter that the data is outdated and associated with respondents who are no longer providing contemporary or current data for viewing behavior. Thus, any outcome produces insights that may be too ambiguous for analyses to be properly performed (e.g., for marketers to reliably act upon).

To overcome the problem of information loss due to sample turnover with respondents being replaced, the exemplary embodiments provide a mechanism to match each removed respondent no longer in the set of respondents to a most similar existing respondent who is currently in the set of respondents. As will become evident below, the matching of the exemplary embodiments provides a reliable estimate of respondent-level changes in viewing behavior over any time interval, regardless of sample turnover. The mechanism according to the exemplary embodiments also measures a similarity between respondents on both a demographic level and a behavioral level such that the integrity of a current set of respondents is protected. The exemplary embodiments may be generalized in which the mechanism is applicable to any survey that collects time-dependent data on its respondents who have a turnover. The exemplary embodiments also have a conservation of data granularity where a similarity chain for matching removed respondents with existing respondents mitigates ambiguities associated with comparing time-dependent data across distant time periods while maintaining both the data set's granularity and its representative integrity.

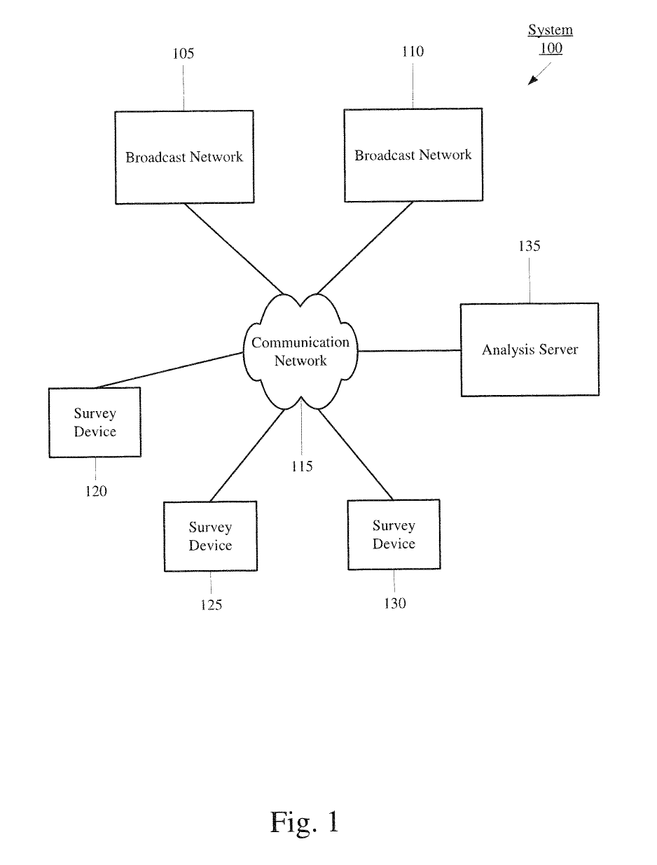

FIG. 1 shows a system 100 according to the exemplary embodiments. The system 100 may utilize features of different distribution models (e.g., a linear distribution model, a non-linear distribution model, etc.) in providing media content or television shows to an audience. More particularly, the shows may be broadcast and tuned into by viewers included in a current set of respondents generating data corresponding to viewing behavior. The system 100 may include a plurality of broadcast networks 105, 110, a communication network 115, a plurality of survey devices 120-130, and an analysis server 135. It should be noted that the system 100 is shown with connections between the components. However, those skilled in the art will understand that these connections may be through a wired connection, a wireless connection, interactions between integrated components or software subroutines, or a combination thereof.

The broadcast networks 105, 110 may represent any one or more components associated with broadcasting a show to the audience. For example, the broadcast networks 105, 110 may include a producer of the show and a distributor of the show (e.g., a network). In a particular embodiment in which a linear distribution model is utilized, a producer may provide a show that is broadcast via a signal by the distributor at a known time for a known duration (e.g., based on a schedule of programming).

The communications network 115 may be any type of network that enables data to be transmitted from a first device to a second device where the devices may be a network device and/or an edge device that has established a connection to the communications network 115. For example, the communications network 115 may be a cable provider network, a satellite network, a terrestrial antenna network, the public Internet, a local area network (LAN), a wide area network (WAN), a virtual LAN (VLAN), a Wi-Fi network, a cellular network, a cloud network, a wired form of these networks, a wireless form of these networks, a combined wired/wireless form of these networks, etc. The communications network 115 may also represent one or more networks that are configured to connect to one another to enable the data to be exchanged among the components of the system 100. The communications network 115 may also include network components (not shown) that are configured to perform further functionalities in addition to providing a conduit to exchange data.

The survey devices 120-130 may be an electronic component associated with a television receiver of a respondent. For example, the survey devices 120-130 may be a set meter. A set meter may be a component incorporated or connected to the television receiver that gathers data associated with the viewing behavior of a household and its respondents. The data is then transmitted to a predetermined location. As will be described in further detail below, according to the exemplary embodiments, the data of the viewing behavior may be transmitted to the analysis server 135.

The set meter may also have an identification associated therewith such that the data of the viewing behavior may be transmitted with the identification. The identification may enable the respondent who is associated with the data to be identified. For example, when the household includes only a single respondent, the identification of the set meter may simply identify the respondent. In another example, when the household includes a plurality of respondents, the identification of the set meter may identify the household. The set meter may also be configured to determine or be provided an input that indicates an identity of the respondent. In this manner, the set meter may include further data that is transmitted such as the identity of the respondent along with the identification of the set meter. Accordingly, identification of the respondent may be properly associated with the data of the viewing behavior.

It is noted that the exemplary embodiments are described with regard to the respondents utilizing the survey devices 120-130. However, those skilled in the art will understand that there are other manners in which viewing behavior may be provided for analysis. For example, a respondent may manually track what is being watched. Specifically, a respondent may maintain a viewer diary that is transmitted to the analysis server 135.

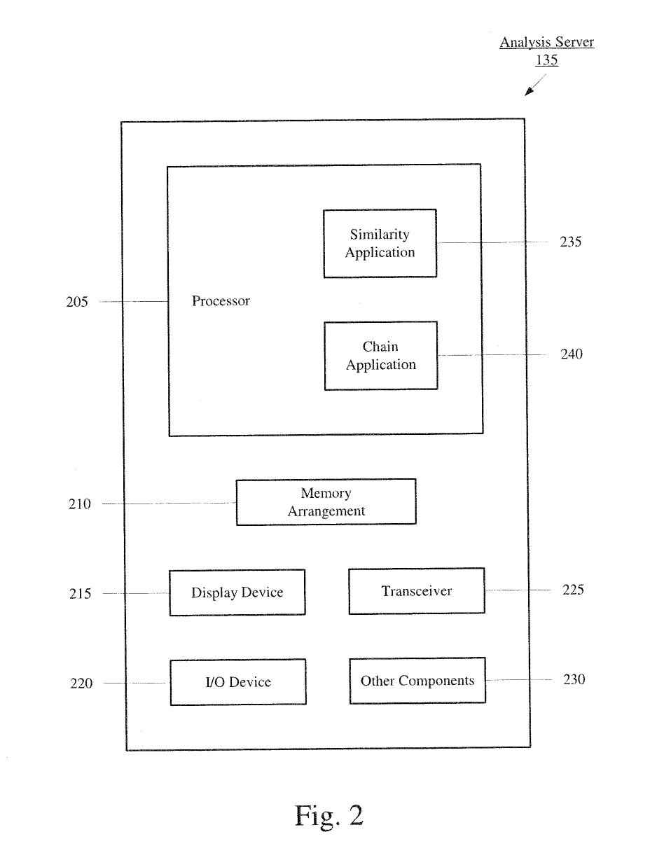

According to the exemplary embodiments, the analysis server 135 may perform a variety of different operations to match a removed respondent to a current respondent. FIG. 2 shows the analysis server 135 of FIG. 1 according to the exemplary embodiments. The analysis server 135 may include a processor 205, a memory arrangement 210, a display device 215, an input/output (I/O) device 220, a transceiver 225, and other components 230 (e.g., an audio input device, an audio output device, a battery, a data acquisition device, ports to electrically connect the media player 150 to other electronic devices, etc.).

The processor 205 may be configured to execute a plurality of applications of the analysis server 135. For example, the processor 205 may execute a similarity application 235 and a chain application 240. As will be described in further detail below, the similarity application 235 may determine which one among a plurality of respondents within a set of respondents associated with a current time period is most similar to a removed respondent. The chain application 240 may create and/or update a chain that includes the selected current respondent and the removed respondent.

It should be noted that the above noted applications being an application (e.g., a program) executed by the processor 205 is only exemplary. The functionality associated with the applications may also be represented as a separate incorporated component of the analysis server 135 or may be a modular component coupled to the analysis server 135, e.g., an integrated circuit with or without firmware.

The memory arrangement 210 may be a hardware component configured to store data related to operations performed by the analysis server 135. Specifically, the memory arrangement 210 may store the data of the viewing behavior from the respondents (e.g., from the survey devices 120-130 or from a viewing diary). The memory arrangement 210 may also store the different chains that are created. The display device 215 may be a hardware component configured to show data to a user. For example, the chains that are determined may be shown on the display device. The I/O device 220 may be a hardware component that enables the user to enter inputs. For example, the I/O device 220 may receive an input of a respondent, a show, a demographic characteristic, etc. to show results of viewing behavior that includes the respondents (former and current) in the chain. The transceiver 225 may be a hardware component configured to transmit and/or receive data in a wired or wireless manner. Specifically, the transceiver 225 may be used with the communications network 115.

According to the exemplary embodiments, the analysis server 135 may determine how to maintain data of viewing behavior for respondents who have been removed from a sample pool. As described above, the system 100 may utilize a model in which a time period has a set of respondents who provide respective data of viewing behavior. Thus, a first time period may have a first set of respondents and a second, ensuing time period may have a second, different set of respondents. Specifically, the first and second sets of respondents may have at least one common respondent but also has at least one different respondent by having a respondent from the first set being removed, by having a respondent from the first set being removed for a new respondent in the second set, or by having a new respondent being added in the second set. Thus, to maintain information of viewing behavior for the removed respondent, the exemplary embodiments provide a mechanism to determine the viewing behavior of the removed respondent based upon correlated viewing behavior of a matched current respondent.

As noted above, the analysis server 135 may perform a matching operation in which a removed respondent is matched with a current respondent. Specifically, the similarity application 235 may perform this matching operation. The similarity application 235 may utilize different characteristics between the removed respondent and the current respondents to determine an optimal match. In a first example, the similarity application 235 may utilize demographic information. For example, a respondent's age, gender, race, geographic location, income, occupation, etc. may be considered. In a second example, the similarity application 235 may utilize viewing information. Specifically, the shows being watched and for how long by a respondent may be considered. Accordingly, the similarity application 235 may generate a respective similarity value between the removed respondent and each of the current respondents (or selected ones thereof) based on the demographic information and the viewing information. The current respondent having a highest similarity value may be determined to be an optimal match to the removed respondent.

It is noted that the similarity application 235 may generate the similarity values in a variety of manners. In a first manner, the similarity application 235 may utilize a filtering operation. Specifically, the similarity application 235 may utilize the demographic information or the viewing information to determine a subset of the current respondents who continue to be analyzed for a match. For example, the similarity application 235 may utilize the demographic information to eliminate select current respondents who have a low probability of being an optimal match to the removed respondent. In another example, the similarity application 235 may utilize an opposite operation in which the viewing information is used to eliminate select current respondents. Accordingly, the similarity application 235 may only be required to determine similarity values for the subset of current respondents. In a second manner, the similarity application 235 may utilize a thorough operation in which a similarity value is generated for each of the current respondents.

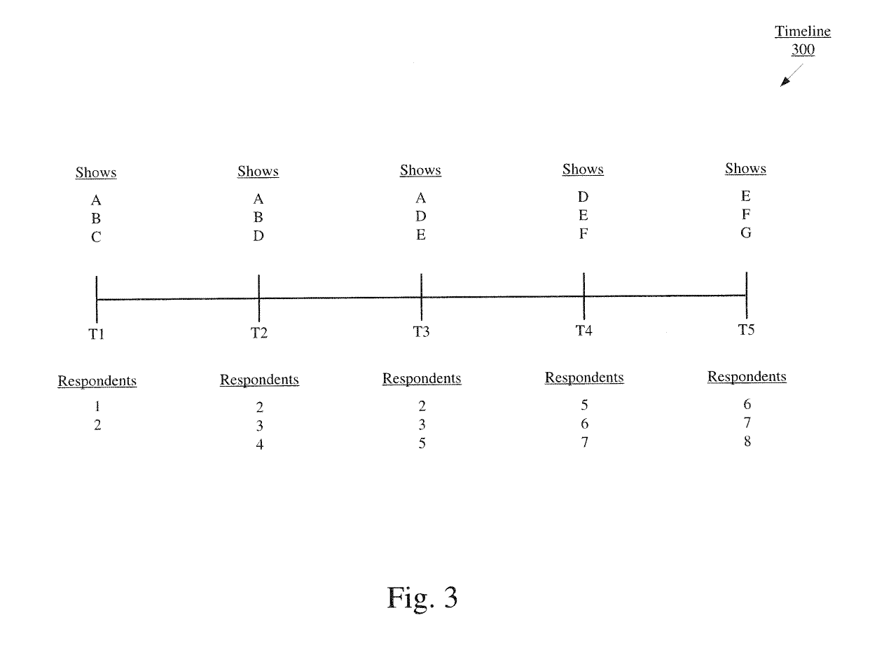

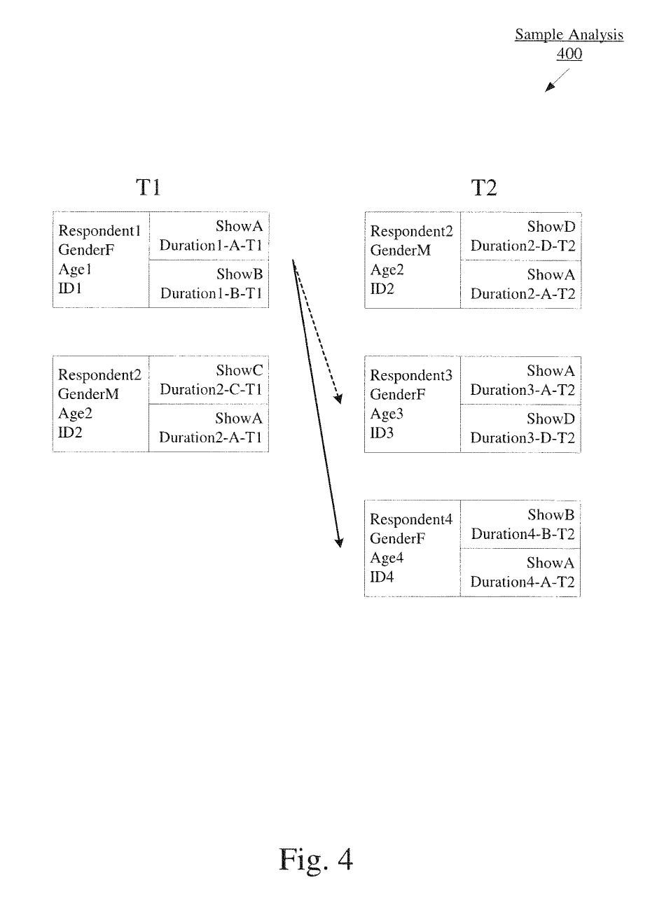

To further illustrate the manner in which the demographic information and the viewing information are used to determine an optimal match, FIG. 3 shows a timeline 300 according to the exemplary embodiments and FIG. 4 shows a sample analysis 400 of the timeline 300 according to the exemplary embodiments. It is noted that the example described herein with FIGS. 3 and 4 are exemplary only and there may be various differences and variants that those skilled in the art will understand to be covered by the exemplary embodiments.

The timeline 300 illustrates an exemplary period of time including a plurality of timeframes. For example, in a first timeframe T1, a first set of shows (e.g., showA, showB, showC) may be watched by a first set of respondents (e.g., respondent1, respondent2) associated with the timeframe T1. In a second timeframe T2, a second set of shows that may or may not have common shows (e.g., showA, showB, showD) may be watched by a second set of respondents (e.g., respondent2, respondent3, respondent4) associated with the timeframe T2. In a third timeframe T3, a third set of shows (e.g., showA, showD, showE) may be watched by a third set of respondents (e.g., respondent2, respondent3, respondent5) associated with the timeframe T3. In a fourth timeframe T4, a fourth set of shows (e.g., showD, showE, showF) may be watched by a fourth set of respondents (e.g., respondent5, respondent6, respondent7) associated with the timeframe T4. In a fifth timeframe T5, a fifth set of shows (e.g., showE, showF, showG) may be watched by a fifth set of respondents (e.g., respondent6, respondent7, respondent8) associated with the timeframe T5.

The timeframes T1-T5 may illustrate how shows and respondents change over time. Initially, the timeframes T1-T5 may be at different points of time. For example, the timeframes T1-T5 may be for a given month (e.g., T1 is for January 2015, T2 is for February 2015, T3 is for March 2015, etc.). In another example, the timeframes T1-T5 may be for different lengths of time such as 3-month or 6-month time periods. It should be noted that the duration between the timeframes T1-T5 being a constant change is only exemplary. The timeframes T1-T5 may utilize any predetermined, constant, dynamic, or fluctuating duration. For example, instead of a calendar based point of time, the timeframes T1-T5 may be when a change in the shows, a change in the respondents, or a change in both is detected.

As noted above, the turnover time for a respondent may be relatively short (e.g., 6 months). Thus, in a given year, the same respondent remaining in the sample pool in which data for viewing behavior is determined has a low probability. As shown in the timeline 300, by the timeframe T4, an entirely different set of respondents are included in the sample pool from the timeframe T1. In addition, the shows being watched may also change over time in a substantially similar manner as the respondents. As shown in the timeline 300, by the timeframe T4, an entirely different set of shows are also included in the sample pool from the timeframe T1. As those skilled in the art will understand, viewing information is time-dependent as shows may only be available to be watched during certain periods of time of the year. Accordingly, a longer change in time in the timeframes T1-T5 may result in less overlap of the sets of shows that are being watched (and available).

The sample analysis 400 may illustrate how the similarity application 235 determines the optimal match for a removed respondent. Specifically, the sample analysis 400 may be from the timeframe T1 to the timeframe T2. Thus, a current timeframe may be the timeframe T2 while an expired, immediately previous timeframe may be the timeframe T1. Based on the timeline 300, the shows that are being watched by the respondents has changed in which showA, showB, and showC were watched in the timeframe T1. However, in the timeframe T2, showA and showB are still being watched but showC is no longer being watched while showD is now being watched. The respondents have also changed in which respondent1 has been removed while respondent3 and respondent4 have been added. Thus, in the sample analysis 400, the analysis server 135 may determine that the respondent1 has been removed and a match is to be determined for the removed respondent1.

The information tracked in the timeframe T1 and the timeframe T2 may also include information specific to each of the respondents. As illustrated, the viewing behavior for each respondent may track the name, the gender, the age, and the unique identification of the respondent. That is, this information may correspond to the demographic information. For example, in the timeframe T1, the respondent1 has a genderF, an age1, and an ID1 while the respondent2 has a genderM, an age2, and an ID2. The viewing behavior for each respondent may also track the shows being watched and for how long. For example, in the timeframe T1, the respondent1 watched showA for duration1-A-T1 and showB for duration1-B-T1 while respondent2 watched showC for duration2-C-T1 and showA for duration2-A-T1. That is, this information may correspond to the viewing information. The demographic information may provide a demographic value while the viewing information may provide a viewing value. The demographic value and the viewing value may be portions of a similarity value used by the analysis server 135 that is used to determine the optimal match for a removed respondent. It should be noted that the demographic data and the viewing data are only exemplary and each of these types of data may include more or less data. For example, demographic data may further include marital status, income bracket, race, etc. Viewing data may further include number of viewers in a household, when during the broadcast did the respondent tune to the show, etc.

In a substantially similar manner, in the timeframe T2, the respondent2 maintains the genderM, the age2, and the ID2 for the demographic information and the responent2 watches showD for duration2-D-T2 and showA for duaration2-A-T2. The respondent3 has a genderF, age3, and ID3 and the respondent3 watches showA for duration3-A-T2 and showD for duration3-D-T2. The respondent4 has a genderF, age4, and ID4 and respondent4 watches showB for duration4-B-T2 and showA for duration4-A-T2.

In performing the matching functionality, the similarity application 235 may initially perform a filtering operation. As described above, one of the parameters (e.g., demographic information or viewing information) in performing the matching functionality of the similarity application 235 may be used to eliminate one or more of the current respondents from consideration as an optimal match to the removed respondent1. Thus, the following exemplary operation to generate the similarity value may be performed in a more efficient manner with less required processing.

In a particular example, respondent1 may be assumed to be female, age 35, watches showA for 200 minutes in timeframe T1, and watches showB for 200 minutes in timeframe T1. Respondent2 may be assumed to be male, age 21, watches showC for 300 minutes in timeframe T1, watches showA for 50 minutes in timeframe T1, watches showD for 200 minutes in timeframe T2, and watches showA for 100 minutes in timeframe T2. Respondent3 may be assumed to be female, age 37, watches showA for 250 minutes in timeframe T2, and watches showD for 100 minutes in timeframe T2. Respondent4 may be assumed to be female, age 35, watches showB for 400 minutes in timeframe T2, and watches showA for 100 minutes in timeframe T2.

Using this particular example, the initial filtering operation may result in the similarity application 235 removing respondent2 as a consideration for an optimal match for the removed respondentl. For example, the gender mismatch and the age gap may be indicative of a poor match. Thus, in an exemplary embodiment, the gender mismatch may provide a first value (e.g., 100) and the age gap may provide a second value (e.g., 14). Addition of the values for the demographic information (e.g., a combined demographic value) may be compared to a predetermined value (e.g., 50). When the combined demographic value is greater than the predetermined value, the current respondent2 may be considered a poor match and removed from consideration.

It is noted that the demographic information illustrated in the sample analysis 400 is only exemplary. That is, the use of only the gender and age is only exemplary. Those skilled in the art will understand that various other types of demographic information may be used and incorporated into the combined demographic value. It is also noted that the predetermined value may also be updated based on the number and types of demographic information used in determining the combined demographic value. It is further noted when only a single type of demographic information is used, the combined demographic value described above may be a single demographic value.

In contrast to the respondent2, the respondent3 has a gender match resulting in a first value (e.g., 0) and an age gap resulting in a second value (e.g., 2) to generate a combined demographic value (e.g., 2). As the combined demographic value is less than the predetermined value (e.g., 50), the respondent3 may be included as an option for a match. The respondent4 has a gender match resulting in a first value (e.g., 0) and an age gap resulting in a second value (e.g., 0) to generate a combined demographic value (e.g., 0). As the combined demographic value is less than the predetermined value (e.g., 50, the respondent4 may also be included as an option for a match. In this manner, the filtering operation may be performed.

Once the demographic information has been used to filter out unlikely matches, the analysis application 135 may utilize the viewing information to determine the optimal match. Specifically, a comparison of the watched shows and the respective durations for the removed respondent1 may be compared to the watched shows and the respective durations for the filtered current respondents (e.g., respondent3 and respondent4). In a specific implementation, a viewing behavior vector may be utilized. As illustrated, the shows that were watched by respondentl, respondent3, and respondent4 include showA, showB, and showD. Thus, the vector may be durations for each of these shows (e.g., [showA duration, showB duration, showD duration]). Accordingly, the vector for the respondent1 may be [duration1-A-T1, duration1-B-T1, 0]; the vector for the respondent3 may be [duration3-A-T2, 0, duration3-D-T2]; and the vector for the respondent4 may be [duration4-A-T2, duration4-B-T2, 0]. Using these vectors, the similarity application 235 may utilize any calculation to generate a viewing value. For example, the similarity application 235 may utilize a cosine distance between the vector of removed respondent1 to the filtered current respondents. Accordingly, the cosine distance between removed respondent1 and current respondent3 is 0.66 while the cosine distance between removed respondent1 and current respondent4 is 0.86.

Once the filtered current respondents have a viewing value generated (e.g., cosine distance to the removed respondent1), the similarity application 235 may select the filtered current respondent having the highest viewing value. In the instant case, the respondent4 may be selected. Thus, the similarity application 235 may determine the optimal match for the removed respondent and all removed respondents from timeframe T1 to timeframe T2.

It should be noted that the demographic information and/or the demographic value may also influence how the viewing value is utilized. For example, when the viewing value for the removed respondent and a first current respondent is identical to the viewing value for the removed respondent and a second current respondent, the similarity application 235 may consider the demographic value to break the tie. That is, current respondent having the lowest demographic value may be selected in the event of a tie. In another embodiment, the demographic value may be utilized for all current (or filtered) respondents. If certain factors were considered more important than others and a different set of circumstances were present than what is illustrated in the sample analysis 400, the similarity application 235 may determine that the viewing value for respondent3 is higher than the viewing value for respondent4. However, the demographic value may be incorporated that still results in respondent4 being selected as the optimal match as the combination of the demographic value and the viewing value results in respondent4 being more optimal as a match than respondent3.

It is again noted that the use of the demographic information and the viewing information is only exemplary. The similarity application 235 may also utilize other types of information including other types of demographic information in determining the most optimal match for the removed respondent. Furthermore, the values generated for each type of demographic information may also be scaled such that one type of demographic information has a greater weight and consideration over other types of demographic information. A substantially similar implementation may be used for the viewing information where a show watched for a duration greater than a predetermined threshold may be weighted to have more consideration in determining the optimal match.

It is also noted that the order in which the similarity application 235 utilizes the demographic information and the viewing information is only exemplary. That is, the above described configuration in which the demographic information is used first for the filtering operation and the viewing information next to determine the optimal match is only exemplary. In an opposite configuration, the filtering operation may be performed using the viewing value. Thus, when the viewing value is below a predetermined threshold (from using the cosine distance), the current respondents with such a viewing value may be eliminated from consideration. Subsequently, the demographic value may be used in the above described manner to select the optimal match.

As noted above, the analysis server 135 may perform a chain operation in which the matched respondents are associated with one another in a chain. Specifically, the chain application 240 may provide this functionality. The creation of a chain of respondents may allow for two respondents separated by a distant time period (more than one timeframe difference) to still be connected. Specifically, the chain application 240 may build a chain of similar respondents that connect the two distant respondents, each link in the chain of similar respondents being a connection within a next timeframe (so that there is only a one timeframe difference between each link). Thus, for first and second distant respondents, the similarity application 240 may sequentially match the first removed respondent from its corresponding timeframe to a current respondent in the following timeframe for each timeframe that the current respondent is still a part of the sample pool. Subsequently, the current respondent becomes the removed respondent and is matched in a substantially similar manner until the second respondent is reached, thereby creating the chain.

In a particular example, the respondent1 may be removed in timeframe T2. Using the above described mechanism of determining the optimal match, the respondent4 may be determined to be an optimal match. Thus, the chain application 240 may create a chain via a link between the respondentl and the respondent4. However, in timeframe T3, the respondent4 may be removed. Thus, using the above described mechanism and based on the demographic information and the viewing information, the similarity application 235 may determine the optimal match between the respondent4 and one of the current respondents (e.g., respondent2, respondent3, respondent5). For example, the respondent5 may be the optimal match to respondent4. Thus, the chain application 240 may update the chain such that the chain includes respondent1, respondent4, and respondent5. When the respondent5 is removed, an optimal match for respondent5 may then be identified. This process may continue to update the chain.

It is noted that the chain application 240 may incorporate other information into the chain. For example, the cosine distance may be converted into a percentage value. Thus, the percentage value may indicate a strength of an affinity or connection for the link in the chain between respondents. This may be particularly relevant when the link in the chain between respondents is relatively weak but the best option among the other available choices in the respondents. Accordingly, the analysis server 135 may determine whether a chain or a link should be given as much credence based on the percentage or confidence in each link.

The chain application 240 may further have an expiration value that is used in maintaining the chain. For example, a link in the chain that exceeds a predetermined threshold (e.g., 10 years) may be removed from the chain. In this manner, the chains being maintained may be for a relevant time period.

In creating and updating the chain, removed respondents may still provide data for viewing behavior for analysis. Although no longer in a current sample pool, the removed respondent being matched in a chain to a current respondent, the viewing behavior of the removed respondent may still be tracked. That is, the chain enables the analysis server 135 to estimate changes in future preferences and viewing behavior even though no further data of viewing behavior is being generated for the removed respondent. In this manner, ambiguity for comparing time-dependent data is mitigated as current shows for the current timeframe are being utilized to determine the viewing behavior of the removed respondents. The granularity and representative integrity is also maintained as the chain utilizes continuous associations between timeframes, even over a distant time period.

It is noted that the above description relates to when the respondents are removed from the sample pool of a timeframe. However, this is only exemplary and the removed respondents may also represent any time when viewing behavior information is not being provided. For example, the respondent may be on vacation for an extended period of time or the survey device that records the viewing behavior may malfunction. Thus, during the time duration in which the respondent is not generating the viewing behavior information, the respondent may be considered “removed.” Thus, a link may be created for this “removed” respondent (although still part of the sample pool). When the respondent starts to generate the viewing behavior information once again, the respondent may be considered “added.”

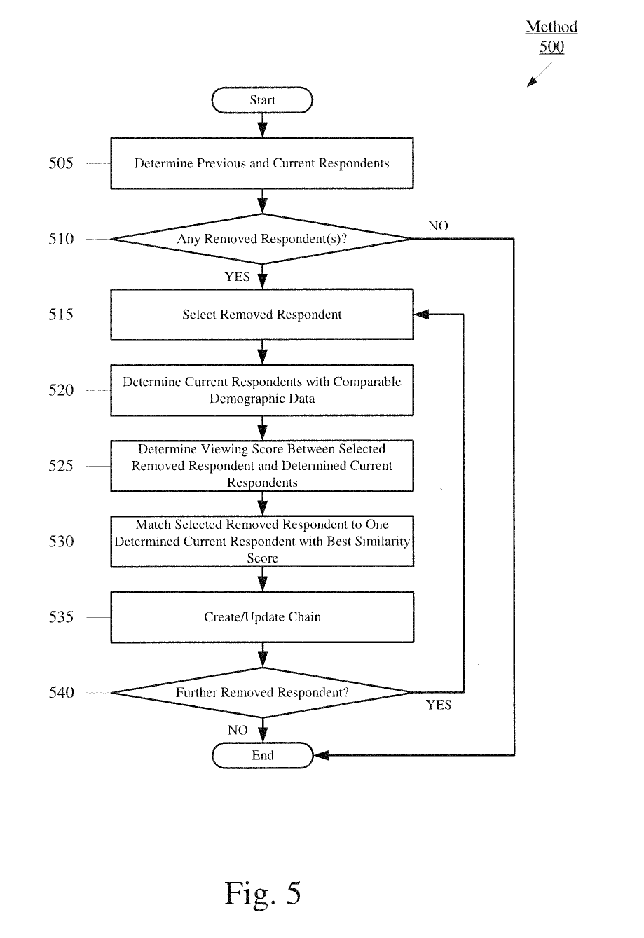

FIG. 5 shows a method 500 of temporally matching a removed respondent with a current respondent according to the exemplary embodiments. The method 500 relates to utilizing demographic information and viewing information to determine an optimal match for a removed respondent. The method 500 is from a perspective of the analysis server 135. The method 500 will be described with regard to the system 100 of FIG. 1, the analysis server 135 of FIG. 2, the timeline 300 of FIG. 3, and the sample analysis 400 of FIG. 4.

In step 505, the analysis server 135 determines the respondents associated with an immediately previous timeframe and a current timeframe. For example, when in the timeframe T2, the immediately previous timeframe may be the timeframe T1, Accordingly, the analysis server 135 may determine that the respondents in the timeframe T1 includes respondent1 and respondent2 while the respondents in the timeframe T2 includes respondent2, respondent3, and respondent4.

In step 510, the analysis server 135 determines whether there are any removed respondents from the timeframe T1 in the current timeframe T2. Although there is a high likelihood that the set of respondents in adjacent timeframes will be different, there is still a possibility that all of the respondents in the timeframe T1 are still in the timeframe T2. For example, the set of respondents may be identical or only new respondents were added without any respondents being removed. As no respondents are removed, the analysis server 135 may end the method 500.

In contrast, as illustrated in the timeline 300, the respondent1 may be removed. If the analysis server 135 determines that at least one respondent is removed, the analysis server 135 continues the method 500 to step 515. In step 515, the analysis server 135 selects one of the removed respondents. For example, if in timeframe T2, respondentl may be selected. If in timeframe 4, respondent2 or respondent3 may be selected.

In step 520, the analysis server 135 determines which of the current respondents have comparable demographic information to the selected removed respondent. In an exemplary implementation, this operation may relate to the filtering operation to eliminate current respondents as candidates to be the optimal match for the selected removed respondent. In another exemplary implementation, this operation may generate and store the demographic value between the selected removed respondent and the current respondents.

In step 525, the analysis server 135 determines a viewing score between the selected removed respondent and the current respondents. More particularly, if step 520 is used for the filtering operation, the analysis server 135 determines a viewing score between the selected removed respondent and the filtered current respondents. As described above, a vector for all shows watched between the selected removed respondent and the filtered current respondents may be used. As described above, there may be three total shows and the vector may be for durations that the respondent watched each show. It should be noted that there may be any number of total shows that were watched and the vector may increase or decrease based on the number of watched shows. The viewing score may also be determined using, for example, a cosine distance.

In step 530, the analysis server 135 matches the selected removed respondent to the current respondent having the best similarity score. As described above, the similarity score may be a parameter that indicates an overall optimization as a match for the selected removed respondent. The similarity score may be a combination of the demographic score and the viewing score or may be a utilization of the demographic score and the viewing score in series (in either configuration).

In step 535, the analysis server 135 creates or updates the chain that includes the selected removed respondent and the determined current respondent. For example, if the selected removed respondent and the determined current respondent are not part of any chain, the analysis server 135 may create a new chain. In another example, if the selected removed respondent and/or the determined current respondent are part of a chain, the chain may be updated with the appropriate inclusion as another link in the chain.

In step 540, the analysis server 135 determines if there is at least one further removed respondent. In the case of timeframe T2, there are no further removed respondents and the analysis server 135 may end the method 500. However, in the case of timeframe 4, a first pass of the method 500 may have determined the optimal match and chain for the respondent2. Thus, in step 540, the analysis server 135 returns the method 500 to step 515 to select the other removed respondent3.

The exemplary embodiments provide a device, system, and method temporally matching a first respondent that is no longer generating any data of viewing behavior to a second respondent who is generating data of viewing behavior. In this manner, a chain is created between the respondents and viewing behavior of the first respondent may continue to be provided. Specifically, future viewing behavior data may be determined for the first respondent (relative to the time at which the first respondent discontinues generated data of viewing behavior).

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system such as Microsoft Windows, a Mac platform and MAC OS, a mobile device having an operating system such as iOS or Android, etc. In a further example, the exemplary embodiments of the above described method may be embodied as a program containing lines of code stored on a non-transitory computer readable storage medium that, when compiled, may be executed on a processor or microprocessor.

It will be apparent to those skilled in the art that various modifications may be made in the present invention, without departing from the spirit or the scope of the invention. Thus, it is intended that the present invention cover modifications and variations of this invention provided they come within the scope of the appended claims and their equivalent.

What is claimed is:

1. A method, comprising:
in an analysis server:
determining a first respondent included in a first sample pool for a first timeframe who is absent from a second sample pool including a plurality of second respondents for a second, later timeframe;
determining a similarity value between the first respondent and each of the second respondents; and
generating a link between the first respondent and one of the second respondents where the similarity value is indicative of a match.

2. The method of claim 1, wherein the first timeframe is an immediately prior timeframe to the second timeframe.

3. The method of claim 1, wherein the similarity value comprises at least one of a demographic value and a viewing value.

4. The method of claim 3, wherein the demographic value is based on first demographic information associated with the first respondent and second demographic information associated with each of the second respondents.

5. The method of claim 4, wherein the demographic information comprises a gender, an age, a race, a geographic location, an income, an occupation, a marital status, or a combination thereof.

6. The method of claim 3, wherein the viewing value is based on a first duration of each of at least one show watched by the first respondent and a second duration of each of at least one show watched by each of the second respondents.

7. The method of claim 6, wherein the first duration of each of the at least one show is ordered into a vector.

8. The method of claim 7, wherein the viewing value is calculated using a cosine distance.

9. The method of claim 3, further comprising:
filtering the second respondents based on one of the demographic value and the viewing value; and
determining the one of the second respondents from the filtered second respondents based on the other of the demographic value and the viewing value.

10. The method of claim 1, further comprising:
determining whether at least one of the first respondent and the one of the second respondents is already associated with a chain; and
when at least one of the first respondent and the one of the second respondents is already associated with the chain, updating the chain to include the link.

11. An analysis server, comprising:
a transceiver configured to receive data of viewing behavior associated with a first respondent included in a first sample pool fora first timeframe and a plurality of second respondents for a second, later timeframe; and
a processor configured to determine the first respondent is absent from the second sample pool, the processor configured to determine a similarity value between the first respondent and each of the second respondents, and the processor configured to generate a link between the first respondent and one of the second respondents where the similarity value is indicative of a match.

12. The analysis server of claim 11, wherein the first timeframe is an immediately prior timeframe to the second timeframe.

13. The analysis server of claim 11, wherein the similarity value comprises at least one of a demographic value and a viewing value.

14. The analysis server of claim 13, wherein the demographic value is based on first demographic information associated with the first respondent and second demographic information associated with each of the second respondents.

15. The analysis server of claim 14, wherein the demographic information comprises a gender, an age, a race, a geographic location, an income, an occupation, a marital status, or a combination thereof.

16. The analysis server of claim 13, wherein the viewing value is based on a first duration of each of at least one show watched by the first respondent and a second duration of each of at least one show watched by each of the second respondents.

17. The analysis server of claim 16, wherein the first duration of each of the at least one show is ordered into a vector.

18. The analysis server of claim 17, wherein the viewing value is calculated using a cosine distance.

19. The analysis server of claim 13, wherein the processor is further configured to filter the second respondents based on one of the demographic value and the viewing value, and wherein the processor is further configured to determine the one of the second respondents from the filtered second respondents based on the other of the demographic value and the viewing value.

20. A method, comprising:
in an analysis server:
determining a first respondent included in a first sample pool for a first timeframe who is absent from a second sample pool including a plurality of second respondents for a second, later timeframe;
determining a demographic value based on first demographic information associated with the first respondent and second demographic information associated with each of the second respondents;
filtering the second respondents based on the demographic value;
determining one of the second respondents from the filtered second respondents based on a viewing value based on a first duration of each of at least one show watched by the first respondent and a second duration of each of at least one show watched by each of the second respondents; and
generating a link between the first respondent and the one of the second respondents.
